(19) United States
(12) Patent Application Publication
(10) Pub. No.: US 2011/0174976 A1
(43) Pub. Date: Jul. 21, 2011

(54) SPECTRAL DETECTOR

(75) Inventors: Eduard J. Meijer, Eindhoven (NL); Johan Lub, Valkenswaard (NL)

(73) Assignee: KONINKLIJKE PHILIPS ELECTRONICS N.V., EINDHOVEN (NL)

(21) Appl. No.: 13/121,418

(22) PCT Filed: Sep. 28, 2009
(86) PCT No.: PCT/IB2009/054232

§ 371 Date: Mar. 29, 2011

(30) Foreign Application Priority Data
Oct. 2, 2008 (EP) 08165741.3

(51) Int. Cl. G02F 1/13; F21V 9/14; B32B 38/00

(52) U.S. Cl. 250/331; 362/19; 156/145

(57) ABSTRACT

The invention relates to a method for manufacturing a spectral detector including a photo detector array and cholesteric liquid crystal material for measuring properties of light over portions of the electromagnetic spectrum. By exposing the cholesteric liquid crystal material for different exposure intensities or exposure times of ultraviolet radiation at different positions on the cholesteric liquid crystal material in a controlled way, portions of the cholesteric liquid crystal material are obtained, each having, in general, its own optical transmission. This invention also relates to a spectral detector manufactured by the inventive method.

### FIELD OF THE INVENTION

The present invention relates to spectral detectors for measuring properties of light over portions of the electromagnetic spectrum. In particular, the present invention relates to a spectral detector including cholesteric liquid crystals and a method for manufacturing such a spectral detector.

### BACKGROUND OF THE INVENTION

In environments illuminated by artificial light sources, lighting management becomes increasingly important. In general, the use of solid state light sources, such as light emitting diodes, allows tuning the color of the emitted light. It is generally desirable to be able to detect, e.g., the color point and the color rendering index of the light in the light source environment, as well as other properties of the light emitted from the light sources over a portion of the electromagnetic spectrum, in order to adjust and control preferred light settings or to create dynamic lighting atmospheres. Moreover, it is preferable that such detection can be performed in an unobtrusive manner. In addition, it is desirable to be able to determine properties, such as those above, of light incident on certain positions in the lighting environment, such as an artificially lighted room. Thus, not only the flux, but also spectral information of the light sources is of interest. It would therefore be desirable to have an inexpensive, unobtrusive, and easily manufactured device capable of such detection.

A drawback with known spectral detectors is that they generally require optical components such as prisms, gratings, etc., which require alignment and space, and thus, are expensive and bulky, and therefore cannot be arranged unobtrusively at the desired location to perform spectral detection.

Document GB-1372921A, referred to as D1 in the following, discloses an optical filter system employing liquid crystalline substances, the filter comprising a linear polarizer member, a linear analyzer member, and a plurality of liquid crystalline films positioned between the linear polarizer member and the linear analyzer member. According to D1, the optical filter system is capable of transmitting several wavelength bands of radiation.

A drawback with D1 is that in order to achieve transmissivity of several wavelength bands of radiation, several liquid crystalline films are required, which makes the process of manufacturing such an optical filter system expensive and cumbersome.

### SUMMARY OF THE INVENTION

Thus, it is an object of the present invention to provide a spectral detector capable of detecting properties of light over portions of the electromagnetic spectrum that is an improvement over known spectral detectors.

A further object of the present invention is to provide a method for manufacturing such a spectral detector.

Liquid crystals are substances that exhibit a phase between the conventional liquid and solid phases. For instance, a liquid crystal may be flowing like a liquid, but the molecules in the liquid crystal may still be arranged and/or oriented as in a crystal. Liquid crystals may be in various phases, which are characterized by the type of molecular ordering that is present in the liquid crystal. In particular, liquid crystals in the cholesteric, or chiral nematic, phase exhibits chirality, or handedness.

The molecules in cholesteric liquid crystals are chiral, that is, they lack inversion symmetry. Cholesteric liquid crystals naturally adopt (without external influences, such as an electric field) an arrangement of long successions of molecules, wherein the general direction of such successions of molecules, the director, varies helically in a direction about a helical axis. Thus, the molecules exhibit a helical structure in the cholesteric phase. The distance over which the helix has rotated 360°, the helical, or chiral, pitch (in the following referred to as simply the pitch), along with the refractive index, the wavelength and angle of incidence of incident light, etc., determine the optical properties of the cholesteric liquid crystal.

In general, a cholesteric liquid crystal mixture consists of nematic liquid crystals and a chiral component that may be liquid crystalline itself. If the pitch is of the order of a wavelength corresponding to visible light (i.e., comprised within the range of wavelengths corresponding to visible light), reflection of light will occur, with the wavelength of reflection λ being

λ=n/(HTP·x),

where n is the mean refractive index of the cholesteric liquid crystal, x is the fraction of the chiral component present in the cholesteric liquid crystal mixture, and HTP is the so called helical twisting power, which is the reciprocal of the pitch for the case x=1. Only light having one (circular) polarization direction is reflected. In order to change the wavelength of reflection, the value of x can be adjusted, or the value of the HTP (the reciprocal of the pitch) can be adjusted. In some cholesteric mixtures, the chiral component in the cholesteric liquid crystal is photoisomerizable, that is, on irradiation of such a mixture, the amount of chiral material x decreases with subsequent formation of a new mixture or material with a different HTP value. For other cholesteric mixtures, the HTP is temperature dependent, and thus, such cholesteric mixtures are thermochromic.

The present invention is based on that the pitch of the helix of chiral molecules can be controlled by the amount of electromagnetic radiation, preferably ultraviolet radiation, that the chiral molecules are exposed to. In this way, by using different exposure intensities and/or exposure times of electromagnetic radiation at different positions on a layer of a cholesteric material, it is possible to in a controlled way achieve portions of the layer of cholesteric material such that, in general, each has its own optical transmission. In combination with a photodetector array, or a photo sensor, an optical spectral detector can be achieved that is capable of measuring properties of light over different portions of the electromagnetic spectrum. In this way, a spectral detector can be obtained that has several advantages as described in the following.

According to a first aspect of the invention, there is provided a spectral detector including a layer of cholesteric liquid crystal as defined by the independent claim 1, which presents several advantages over known devices. The inventive device can in a simple way directly be used to measure properties of light over different portions of the electromagnetic spectrum, without the need for any auxiliary optical components, such as prisms, gratings, chromators, etc., Moreover, by using the spectral detector according to the invention, such measurements can be performed in an unobtrusive way in a variety of desired lighting environments due to the small form factor, that is the physical shape and size, of the spectral detector of the invention. Because of the small form factor, the spectral detector can readily be integrated in a number of applications. Furthermore, such a spectral detector can be manufactured in an inexpensive manner.

According to a second aspect of the invention, there is provided a method for manufacturing such a spectral detector, the method being as defined by the independent claim 7. The spectral detector thus manufactured has the advantages already presented above.

According to a third aspect of the invention, there is provided an optical biosensor including a spectral detector according to the first aspect of the invention or embodiments thereof. Due to the small form factor of the spectral detector according to the first aspect of the invention, the optical biosensor can advantageously readily be integrated in a medical probe, without the need for long fibers.

According to a fourth aspect of the invention, there is provided a lighting device, which includes one or more light emitting diodes and a spectral detector according to the first aspect of the invention or embodiments thereof. Such a lighting device could advantageously be adapted to provide, e.g., a stable color point feedback loop.

According to a fifth aspect of the invention, there is provided a light-therapeutic device, for use in therapies employing light, such as wound healing, skin type detection, ultraviolet and solar spectral detection, phototherapy, etc., including a spectral detector according to the first aspect of the invention or embodiments thereof. Such therapies generally require means for spectral detection and/or monitoring in order to be efficient, which the inventive spectral detector provides in an inexpensive and unobtrusive manner.

According to a sixth aspect of the invention, there is provided a spectral detector manufactured using a method according to the second aspect of the invention or embodiments thereof. The spectral detector thus manufactured has the advantages as presented above.

According to an embodiment of the present invention, the at least two polarizers are arranged such that one of said polarizers has a crossed orientation with respect to at least one of the other polarizers. By such a configuration, a bandpass filter is produced, which converts light incident on the spectral detector having a certain wavelength band to circularly polarized light having a narrow wavelength band around a wavelength defined by the pitch of the helix of the chiral molecules included in the spectral detector and the mean refractive index of the cholesteric material. Thus, only circularly polarized light within a well-defined wavelength range is transmitted through the polarizers and the cholestric material to the photosensor array.

According to another embodiment of the present invention, the cholestric liquid crystal material preferably is crosslinked. Thus, the molecular structure of the cholestric liquid crystal material is fixated and hardly any thermochromic or photochromic effects can be observed. Thereby, the spectral detector is stable against exposure of electromagnetic radiation and temperature variations such that the transmission characteristics of the components arranged on the photo detector array changes only negligibly, or preferably, does not change at all, with temperature changes and/or exposure to, e.g., ultraviolet radiation.

According to yet another embodiment of the present invention, the portions of the layer including cholesteric liquid crystal are arranged such that a ray of light passing through the layer passes through cholesteric liquid crystal material having substantially identical helical pitch. Preferably, the electromagnetic radiation consists of visible light. By this configuration, a ray of light incident on the spectral reflector in general passes through only a single well-defined bandpass filter, having a certain optical transmission characteristics defined by the pitch of the helix of the chiral molecules in the associated portion of the layer including cholesteric liquid crystals, before striking the photo detector array, thus simplifying any potential subsequent processing of signals generated in the photo detector array.

According to yet another embodiment of the present invention, the spectral detector further includes an orientation layer (or alignment layer) for orienting (aligning) the layer including cholesteric liquid crystal material. Such an orientation layer imparts a preferred orientation to liquid crystal molecules in its vicinity, by defining the actual arrangement of the liquid crystal director that is situated close to the boundary of the orientation layer. This preferred orientation tends to persist even away from the orientation layer, due to the strong interaction of liquid crystal molecules.

According to yet another embodiment of the present invention, the layer including cholesteric liquid crystal material preferably has a thickness of at least 4 μm. The minimum layer thickness of the layer including cholesteric liquid crystal is determined by the minimum number of reflections that is required to achieve a good filter response, which in turn is determined by the longest wavelength of visible light (that is, red light, having a wavelength ˜0.7 μm).

According to yet another embodiment of the present invention, the step of applying electromagnetic radiation on the layer including cholesteric liquid crystal material includes applying a mask on the spectral detector, the mask having a plurality of apertures having different transmissivity to electromagnetic radiation, preferably ultraviolet radiation, such that the dose of electromagnetic radiation (ultraviolet radiation) does not become the same throughout the extent of the layer including cholesteric liquid crystal material when applying the electromagnetic radiation. By such a method, the variation of the dose of electromagnetic radiation, preferably ultraviolet radiation, as a function of the position on the layer including cholesteric liquid crystal material can be achieved in a simple and robust manner.

According to yet another embodiment of the present invention, the step of applying electromagnetic radiation on the layer including cholesteric liquid crystal material includes applying a mask on the spectral detector in accordance with the embodiment described immediately above, wherein the mask is a gray-level mask.

According to yet another embodiment of the present invention, the step of applying electromagnetic radiation on the layer including cholesteric liquid crystal is performed such that the time of exposure of electromagnetic radiation is different for at least two portions of the cholesteric liquid crystal layer. By this, the variation of the dose of electromagnetic radiation, preferably ultraviolet radiation, as a function of the position on the layer including cholesteric liquid crystal material can easily and controllably be achieved.

According to yet another embodiment of the present invention, the electromagnetic radiation that is applied on the layer including cholesteric liquid crystal comprises ultraviolet radiation.

As the skilled person realizes, it is within the scope of the invention that the features described above with reference to the different aspects and embodiments of the present invention, as well as the features disclosed in the appended claims, can be combined in an arbitrary manner.

Thus, for example, according to one exemplary embodiment of the present invention, the at least two polarizers are arranged such that one of said polarizers has a crossed orientation with respect to at least one of the other polarizers, and the cholestric liquid crystal material is crosslinked. According to another exemplary embodiment of the present invention, the portions of the layer including cholesteric liquid crystal are arranged such that a ray of light passing through the layer passes through cholesteric liquid crystal material having substantially identical helical pitch, and the at least two polarizers are arranged such that one of said polarizers has a crossed orientation with respect to at least one of the other polarizers. According to yet another exemplary embodiment of the present invention, the portions of the layer including cholesteric liquid crystal are arranged such that a ray of light passing through the layer passes through cholesteric liquid crystal material having substantially identical helical pitch, the at least two polarizers are arranged such that one of said polarizers has a crossed orientation with respect to at least one of the other polarizers, and the cholestric liquid crystal material is crosslinked. By such exemplary embodiments of the present invention, combining features of the embodiments described above, configurations are obtained having several advantages as already described above.

It should be understood that the exemplary embodiments of the present invention as shown in the figures are for purpose of exemplification only. Further embodiments of the present invention will be made apparent when the figures are considered in conjunction with the following detailed description and the appended claims.

Furthermore, it is to be understood that the reference signs provided in the drawings are for the purpose of facilitating quicker understanding of the claims, and thus, they should not be construed as limiting the scope of the invention in any way.

### BRIEF DESCRIPTION OF THE DRAWINGS

FIG. 1 is a schematic side view of an exemplary embodiment of the present invention.

FIG. 2 is a schematic side view that illustrates the working principle of the present invention.

FIG. 3 is a schematic side view of another exemplary embodiment of the present invention.

FIG. 4 is a schematic view of yet another exemplary embodiment of the present invention.

FIG. 5 is a schematic view of yet another exemplary embodiment of the present invention.

FIG. 6 is a schematic view of yet another exemplary embodiment of the present invention.

FIG. 7 is a schematic view of yet another exemplary embodiment of the present invention.

### DETAILED DESCRIPTION OF THE EMBODIMENTS

Preferred embodiments of the present invention will now be described for the purpose of exemplification with reference to the accompanying drawings, wherein like numerals indicate the same elements throughout the views. The present invention encompasses also other exemplary embodiments that comprise combinations of features described in the following. Additionally, other exemplary embodiments of the present invention are defined in the appended claims.

FIG. 1 is a schematic side view of an exemplary embodiment of the present invention, wherein a spectral detector 1 according to the exemplary embodiment of the invention comprises a layer 2 including a cholesteric liquid crystal mixture, the cholesteric liquid crystal being such that helices of cholestric liquid crystal molecules in one or more portions of the layer 2 have a different pitch compared to helices of cholestric liquid crystal molecules in other portions of the layer 2. In the exemplary embodiment schematically shown in FIG. 1, the layer comprises three such portions 2a, 2b, and 2c. However, the present invention encompasses other exemplary embodiments that each may comprise any number of such portions. Thus, the pitch of the cholestric liquid crystal molecules in the portions 2a, 2b, and 2c, respectively, are different. Thereby, the portions 2a, 2b, and 2c have different optical transmission characteristics. As shown in FIG. 1, the spectral detector 1 further includes two polarizers 3. Each polarizer can consist of a coatable polarizing material, or even be a polarizer that is commercially available. In this exemplary embodiment, the polarizers are arranged such that one polarizer has a crossed orientation with respect to the other polarizer. Such a configuration results effectively in a bandpass filter that is capable of converting light incident on the spectral detector (from the left in FIG. 1) having a certain wavelength band to circularly polarized light having a narrow wavelength band around a wavelength λ=2np, where p is the pitch of the helix of the chiral liquid crystal molecules and n is the mean refractive index of the cholesteric liquid crystal material. Thus, in the illustrated configuration in FIG. 1, only circularly polarized light within a well-defined wavelength range is transmitted through the polarizers and the cholestric liquid crystal material.

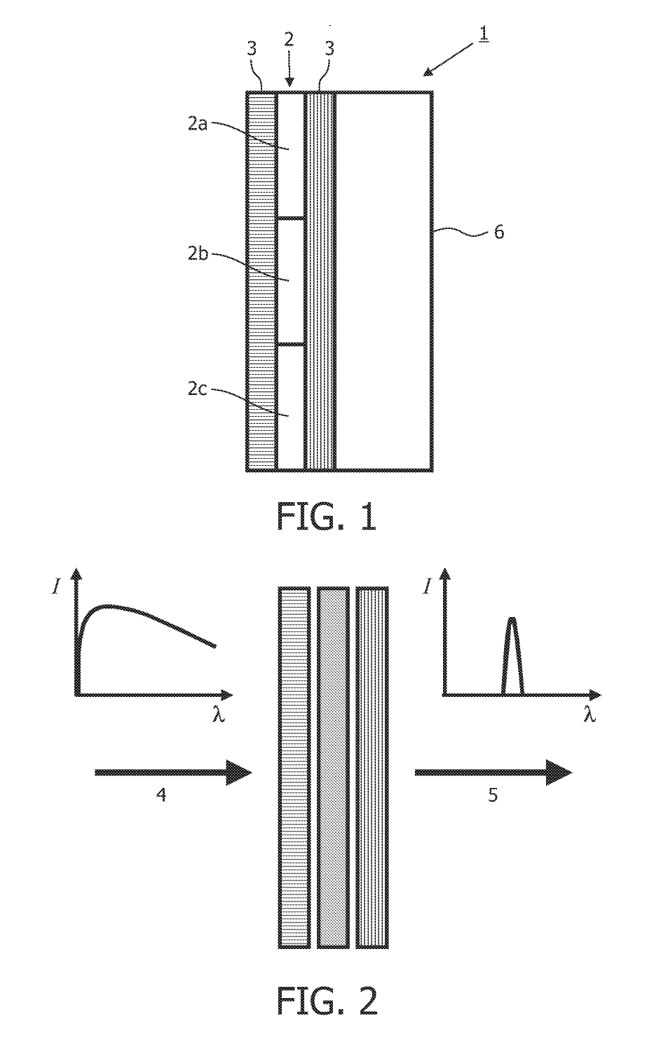

This is further illustrated in FIG. 2, which is a schematic side view of a part of the assembly shown in FIG. 1. FIG. 2 schematically shows incoming light 4 having an exemplary wavelength spectrum, that is the intensity I of light as a function of the wavelength λ of the light, as shown to the left in FIG. 2, and outgoing light 5, having passed through the bandpass filter comprising two polarizers 3, arranged in a crossed orientation relative to each other, and the layer 2 of cholesteric liquid crystal material (in FIG. 2 for simplicity consisting of a single portion only), having an exemplary wavelength spectrum as shown to the right in FIG. 2 consisting of a narrow wavelength band.

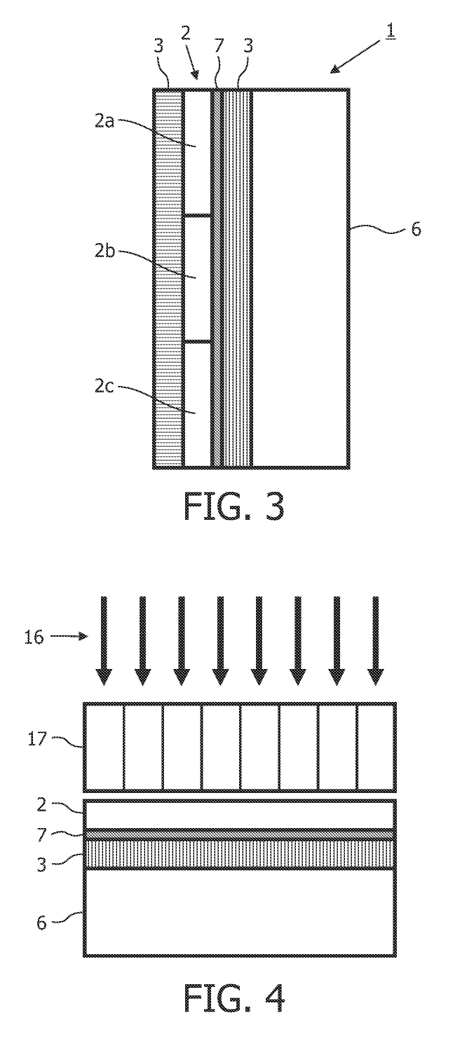

Returning to FIG. 1, the spectral detector 1 according to the illustrated exemplary embodiment of the invention further includes a photo detector array, or photo sensor array, referenced by the numeral 6, which photo detector array 6 is capable of sensing electromagnetic radiation, preferably including visible light, incident on the spectral detector 1 (from the left in FIG. 1). According to the embodiment described with reference to FIG. 1, the photodetector array 6 is arranged adjacent to (or proximate to) one of the polarizers 3. Preferably, the photo detector array 6 consists of one or more of the following: a photodiode array, a charge-coupled device (CCD), or a phototransistor array. However, the photo detector array is not limited to these choices, but rather, any photo detector array that can be used to achieve the function of the first aspect of the invention or embodiments thereof is considered to be within the scope of the invention. Furthermore, wiring, circuits, etc., for coupling the photo detector array to a processing unit, a control unit, analysis equipment, etc. (not shown), have been omitted from FIG. 1 and FIG. 3 for the purpose of facilitating the explanation of the present invention.

FIG. 3 is a schematic side view of another exemplary embodiment of the present invention. In comparison with the exemplary embodiment of the invention illustrated in FIG. 1, the exemplary embodiment of the invention shown in FIG. 3 further includes an orientation layer 7 (or alignment layer) for orienting (aligning) the (liquid crystal molecules of the) layer 2 including cholesteric liquid crystal material. Such an orientation layer imparts a preferred orientation to liquid crystal molecules in its vicinity, by defining the actual arrangement of the liquid crystal director that is situated close to the boundary of the orientation layer. This preferred orientation tends to persist even away from the orientation layer, due to the strong interaction of liquid, crystal molecules. Preferably, the orientation layer 7 is transparent for, inter alia, visible light. The orientation layer preferably consists of polyimide, but other choices are possible, such as polyamides. It should be understood that such other choices are within the scope of the invention.

According to an exemplary embodiment of the present invention, a spectral detector, such as the spectral detector according to the first aspect of the invention or embodiments thereof, can be manufactured by depositing a thin polarizing layer 3 on top of a photo detector array 6, or photo sensor array, such as a photodiode array, a charge-coupled device (CCD), or a phototransistor array, as described above. This exemplary embodiment of the invention is illustrated in FIG. 4. Preferably, an orientation layer 7, e.g., a rubbed polyimide layer, is applied on top of the polarizing layer 3. The purpose of the orientation layer is to orient liquid crystal molecules in its vicinity, as already described above.

Next, a cholesteric liquid crystal mixture is deposited on top of the polarizing layer 3, or alternatively, the orientation layer 7 (if any), such as to form a layer 2 including cholesteric liquid crystal. Subsequently, this cholesteric layer 2 is exposed to electromagnetic radiation 16, preferably ultraviolet radiation, preferably by employing a mask 17 having a plurality of apertures, each aperture having a different transmissivity to ultraviolet radiation, such that the dose of electromagnetic radiation does not become the same (i.e., is different or varies) throughout the extent of the layer 2 including cholesteric liquid crystal when applying the electromagnetic radiation. For example, a gray-level mask that partially blocks ultraviolet radiation may be utilized, for instance, a chromium mask for which the transmission depends on the density of subwavelength chromium dots on the mask.

By using such a mask 17, a variation in helical pitch of the cholesteric material is achieved as a function of position on the layer 2, thus defining different portions of the layer having different spectral responses. It is also possible to vary the exposure time of the electromagnetic radiation 16, preferably ultraviolet radiation, so that the exposure time is different for at least two portions of the cholesteric liquid crystal layer 2.

After defining the different portions of the layer 2 having different spectral responses, the cholesteric material preferably is crosslinked in order to fixate the molecular structure. Crosslinking comprises linking together the molecule chains. Crosslinking can be performed using standard techniques, e.g., by means of chemical reactions that are initiated by heat, pressure, or radiation, or be induced by exposure to a radiation source, such as electron beam exposure or gamma radiation. After the step of crosslinking the cholesteric material, hardly any thermochromic effects can be observed.

Preferably, the thickness of the cholesteric liquid crystal layer 2 is at least 4 μm. The minimum thickness of the layer including cholesteric liquid crystal is determined by the minimum number of reflections that is required to achieve a good filter response, which in turn is determined by the longest wavelength of visible light (that is, red light, having a wavelength ˜0.7 μm). There is a limit on the feasible layer thickness of the layer including cholesteric liquid crystal as well. In case the layer is too thick, it becomes difficult to obtain mono-domains of the cholesteric liquid crystal material prior to the step of crosslinking.

Thereafter, a second polarizing layer is deposited on top of the cholesteric liquid crystal layer (not shown in FIG. 4). Preferably, the second polarizing layer is configured such that it has a crossed orientation with respect to the first polarizing layer 3, as has been described above.

The final spectral resolution of the spectral detector manufactured as above depends on the spacing of the bandpass filters, that is, the spacing between portions of the layer of cholesteric liquid crystal having different spectral responses. These bandpass filters may easily be made to overlap, by choosing values for the helical pitches of the respective cholesteric material that are sufficiently close to each other.

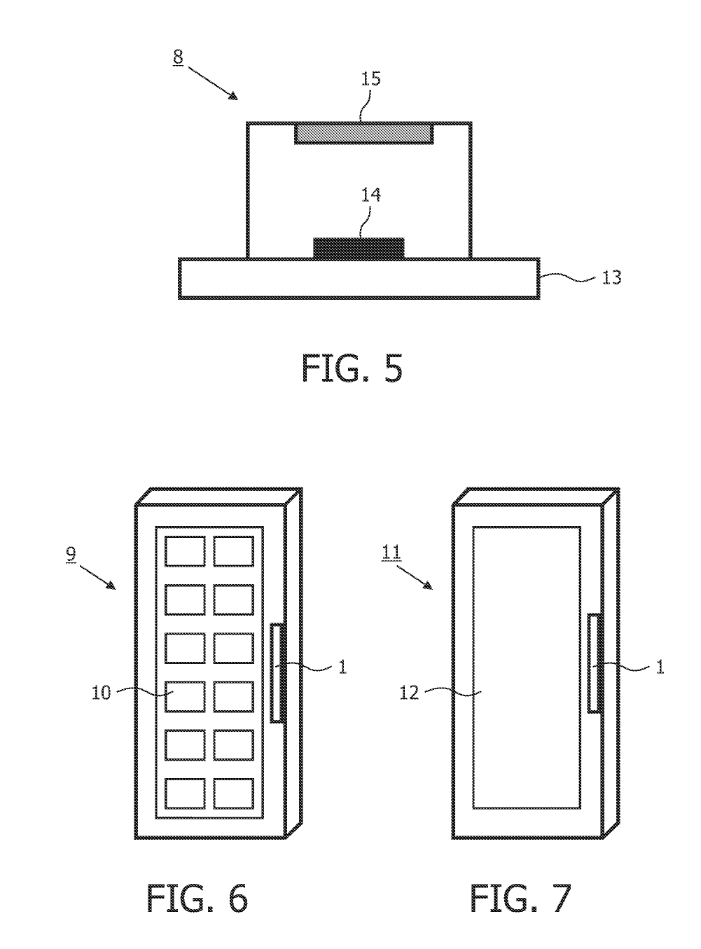

FIGS. 5-7 are schematic views of various exemplary applications employing a spectral detector according to the first aspect of the invention or embodiments thereof.

FIG. 5 is a schematic view of an exemplary embodiment of the present invention, wherein a spectral detector according to the first aspect of the invention or embodiments thereof is coupled to and adapted to be used in conjunction with an optical biosensor 8 for, e.g., probing molecular interactions. According to the embodiment of the invention illustrated in FIG. 5, the optical biosensor 8 comprises a support 13 onto which a sample stage 14 is arranged for holding a sample to be analysed, and analysis equipment 15 including a spectral detector according to the first aspect of the invention or embodiments thereof and preferably further equipment such as one or more light sources as well as other types of optical detectors.

FIG. 6 is a schematic view of an exemplary embodiment of the present invention, wherein a spectral detector 1 according to the first aspect of the invention or embodiments thereof is coupled to and adapted to be used in conjunction with a lighting device 9 including one or more light emitting diodes 10.

FIG. 7 is a schematic view of an exemplary embodiment of the present invention, wherein a spectral detector 1 according to the first aspect of the invention or embodiments thereof is coupled to and adapted to be used in conjunction with a light therapy device 11, according to this particular example a so called light box, having a light emitting screen 12 for light-therapeutic purposes.

Even though the present invention has been described with reference to specific exemplifying embodiments thereof, many different alterations, modifications and the like will become apparent for those skilled in the art. The described embodiments are therefore not intended to limit the scope of the present invention, as defined by the appended claims.

Furthermore, in the claims, the indefinite article “a” or “an” does not exclude plurality. Also, any reference signs in the claims should not be construed as limiting the scope of the present invention.

In conclusion, the present invention relates to a method for manufacturing a spectral detector including a photo detector array and cholesteric liquid crystal material for measuring properties of light over portions of the electromagnetic spectrum. By exposing the cholesteric liquid crystal material for different exposure intensities or exposure times of ultraviolet radiation at different positions on the cholesteric liquid crystal material in a controlled way, portions of the cholesteric liquid crystal material are obtained, each having, in general, its own optical transmission. Furthermore, the invention also relates to a spectral detector manufactured by the inventive method.

1. A spectral detector including:
a layer including a cholesteric liquid crystal mixture, wherein the layer is configured such that the helical pitch of cholesteric liquid crystal mixture in one or more portions of the layer is different compared to the helical pitch of cholesteric liquid crystal mixture in other portions;
at least two polarizers arranged such that the layer including cholesteric liquid crystal is situated between at least two of the polarizers; and
a photo detector array coupled to said layer.

2. The spectral detector according to claim 1, wherein the portions of the layer including cholesteric liquid crystal mixture are arranged such that a ray of light passing through the layer including cholesteric liquid crystal passes through cholesteric liquid crystal material having identical helical pitch.

3. The spectral detector according to claim 1, wherein the at least two polarizers are arranged such that one of the polarizers has a crossed orientation with respect to at least one of the other polarizers.

4. The spectral detector according to claim 1, wherein the cholesteric liquid crystal mixture is crosslinked.

5. The spectral detector according to claim 1, further including an orientation layer (7) for orienting the layer including cholesteric liquid crystal.

6. The spectral detector according to claim 1, wherein the layer including cholesteric liquid crystal mixture has a thickness of at least 4 μm.

7. A method for manufacturing a spectral detector including a photo detector array, a layer including a cholesteric liquid crystal mixture, and at least two polarizers, wherein the polarizers are arranged such that the layer including cholesteric liquid crystal is situated between at least two of the polarizers, the method including the step of: applying electromagnetic radiation on the layer including cholesteric liquid crystal, wherein the degree of exposure of the layer to the electromagnetic radiation varies throughout the extent of the layer, so as to form a plurality of portions of the layer such that the helical pitch of cholesteric liquid crystal mixture in one or more portions is different compared to the helical pitch of cholesteric liquid crystal mixture in other portions.

8. The method according to claim 7, wherein the portions of the layer including cholesteric liquid crystal are arranged such that a ray of light passing through the layer including cholesteric liquid crystal passes through cholesteric liquid crystal material having identical helical pitch.

9. The method according to claim 7, further including the step of arranging at least one of the at least two polarizers such that it has a crossed orientation with respect to at least one of the other polarizers.

10. The method according to claim 7, further including the step of applying an orientation layer for orienting the layer including cholesteric liquid crystal.

11. The method according to claim 7, wherein the step of applying electromagnetic radiation on the layer including cholesteric liquid crystal includes applying a mask (17) on the spectral detector, wherein the mask has a plurality of apertures having different transmissivity to electromagnetic radiation, such that the dose of electromagnetic radiation varies throughout the extent of the layer including cholesteric liquid crystal when applying electromagnetic radiation.

12. The method according to claim 7, further including the step of crosslinking the cholesteric liquid crystal mixture in the layer including cholesteric liquid crystal.

13. An optical biosensor including a spectral detector according to claim 1.

14. A lighting device including one or more light emitting diodes and a spectral detector according to claim 1.

15. (canceled)
